(19) United States
(12) Patent Application Publication
(10) Pub. No.: US 2006/0146684 A1
(43) Pub. Date: Jul. 6, 2006

(54) Disc Surface Protection Means

(76) Inventor: Dan B. Pool, Scottsdale, AZ (US)

Correspondence Address: DESIGNER PRODUCTS;DAN B. POOL, 8180 N. HAYDEN, SUITE D-203, SCOTTSDALE, AZ, 85258, US

(21) Appl. No.: 10/905,443

(22) Filed: Jan. 4, 2005

(51) Int. Cl. G11B 3/70

(52) U.S. Cl. 369/272.1

(57) ABSTRACT

A disc surface protection means comprising of a rim using any of the methods outlined above will significantly reduce the risk of accidentally scratching the disc surface through casual contact with other surfaces. New disc production can include this feature when molded during production with no substantial increase in production costs. Aftermarket bands can be sold to help protect discs already in consumer's possession.

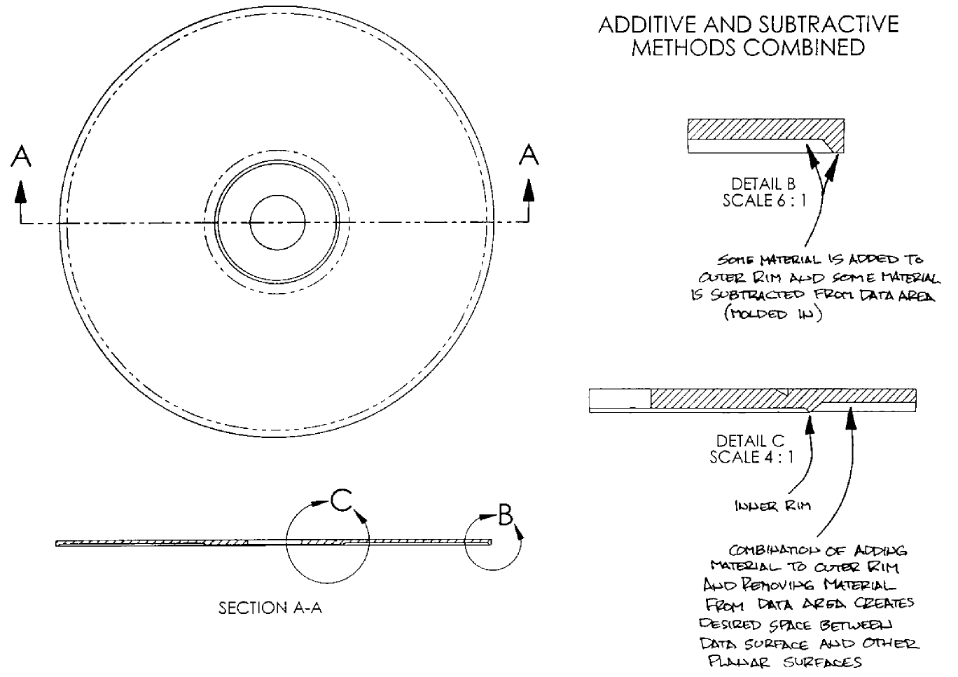

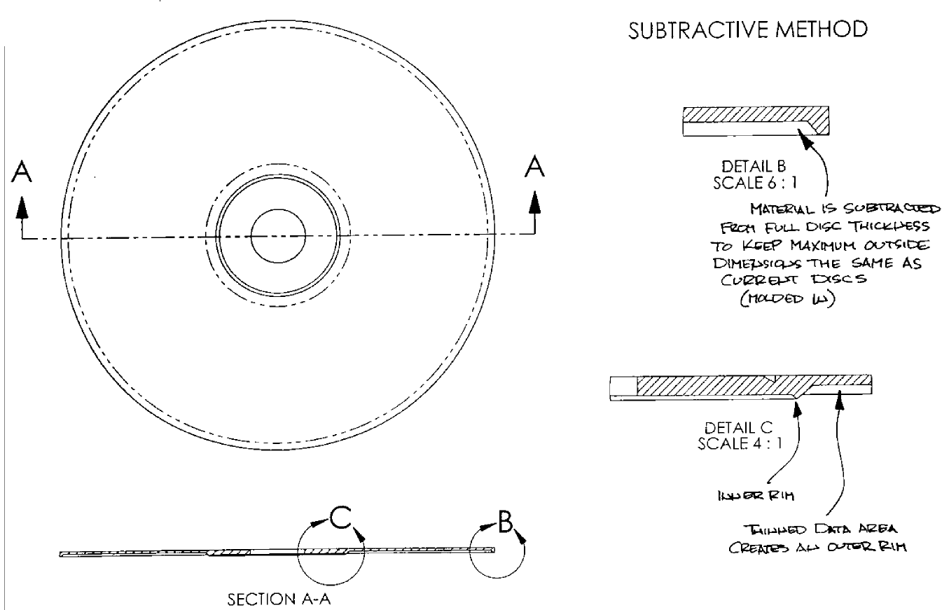

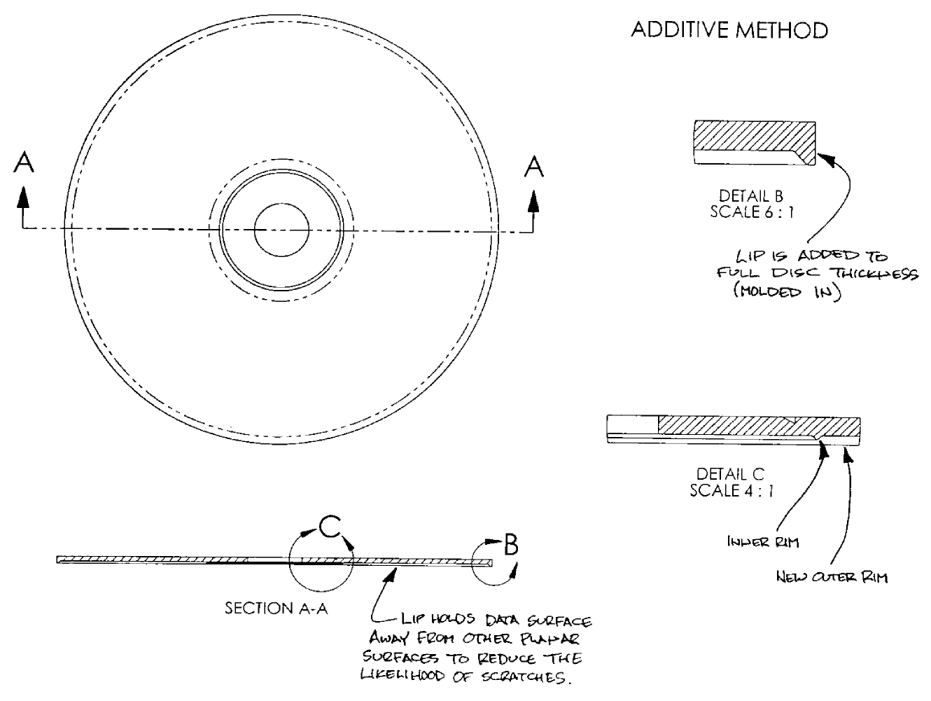

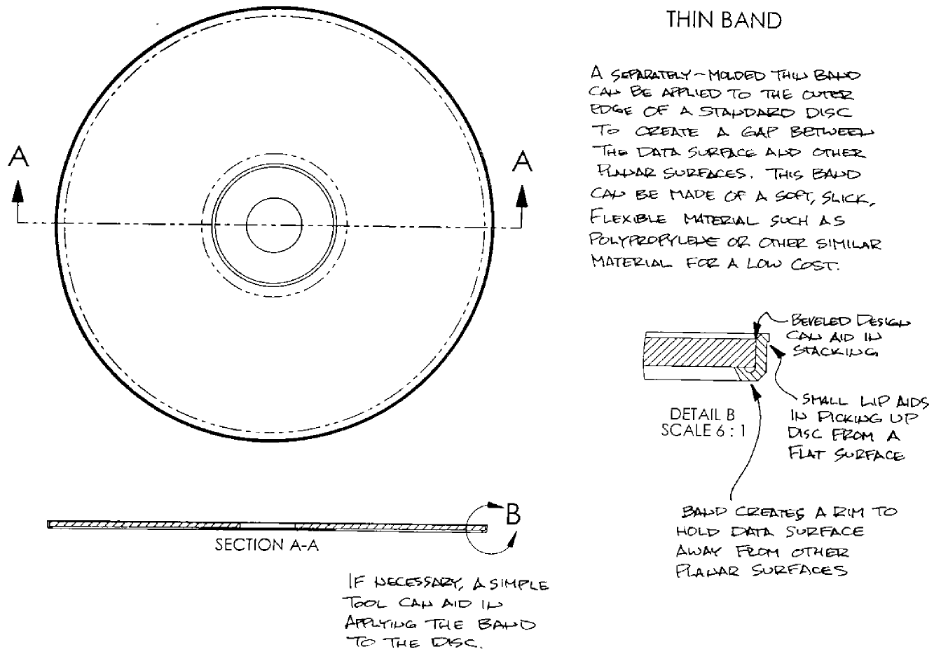

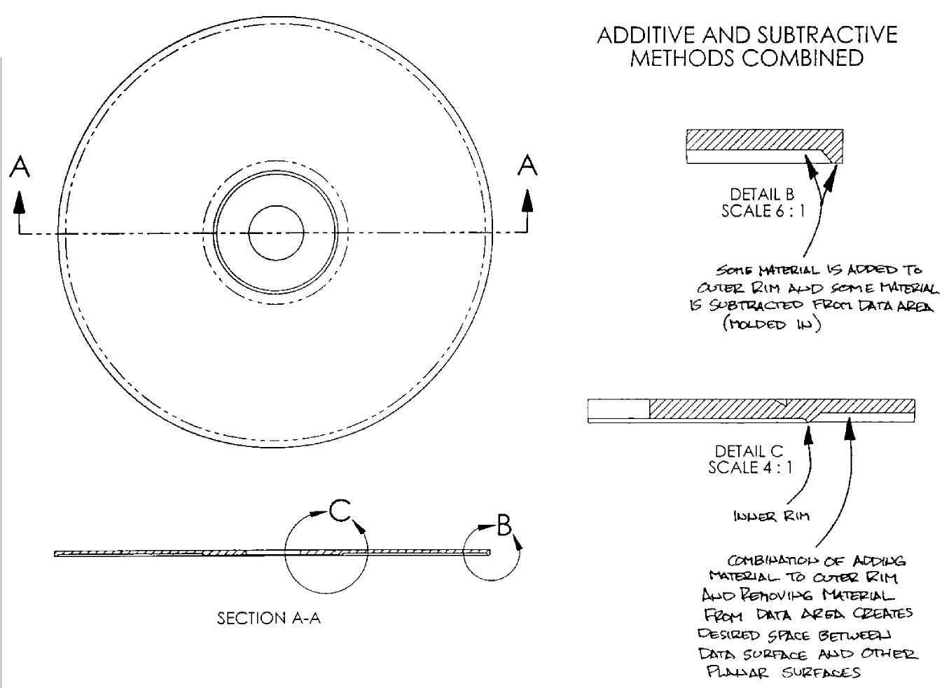

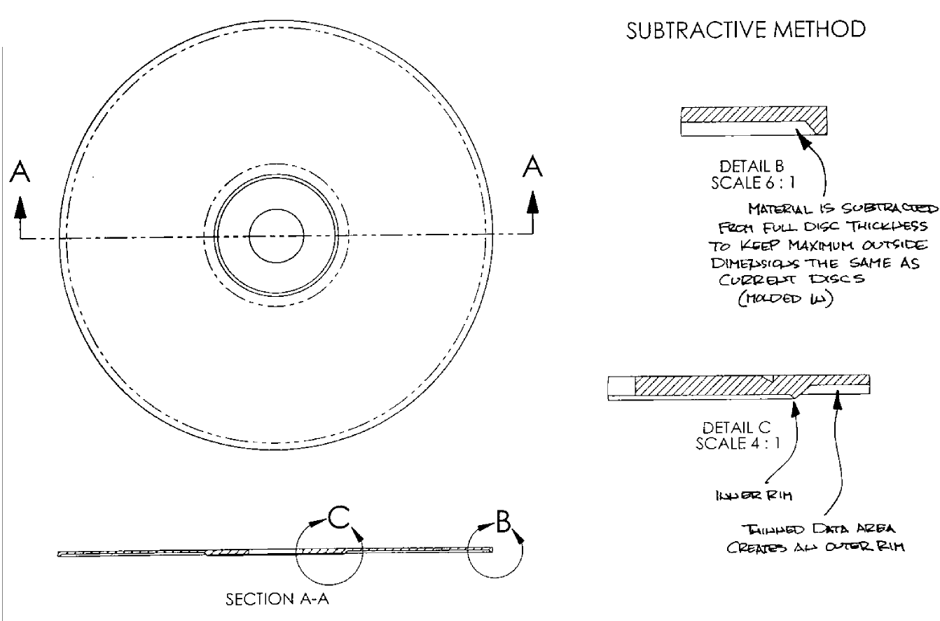

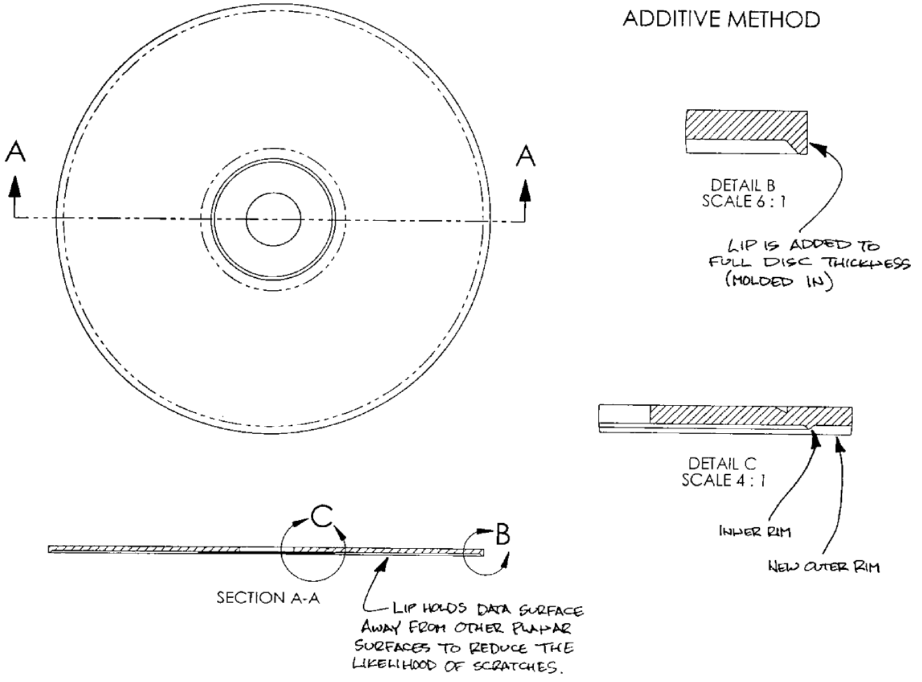

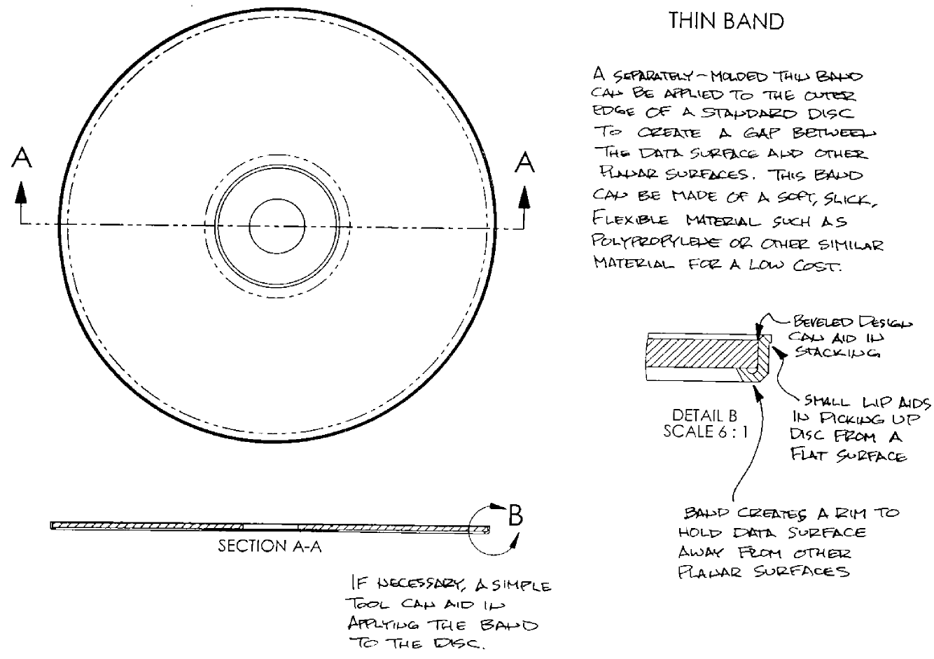

Typical data discs (such as CDs, CD-Rs, DVDs, etc.) are made on relatively soft polycarbonate resin, allowing the data surface to scratch easily. Often such scratches render the disc unreadable by its intended device, and therefore, useless. Although care can be taken to avoid such scratches, often such a disc will become scratched in unexpected ways-such as shuffling through a series of discs, laying a disc on a table with its data surface facing downward, or other such causes.

Our invention helps prevent many of the accidental scratches to these discs by creating a gap between the data surface and any other flat surface equal to or larger than the disc itself (see enclosed figures). The primary means of accomplishing this is to form a rim around the outer perimeter of the disc. The disc would need to be deformed substantially to make contact with a tabletop or other such common planar scratching hazard. The rim can be formed in several ways, on both fixed data discs and writable discs.

What is claimed is:

1. A disc surface protection means using an additive method. This method subtracts thickness from the data surface area of the disc to leave a rim around the perimeter of the disc. This rim can be molded into the form of the disc as part of the manufacturing process or created in some other way.

2. A disc surface protection means as claimed in claim 1 involving a subtractive method. This method subtracts thickness from the data surface area of the disc. This method would preserve the normal inner hub thickness and thin out the region of the disc where the data is printed or written to the disc. This method is advantageous in that the maximum outside dimensions of the disc remain the same as current discs, making compatibility with disc reading/playing devices most probable.

3. A disc surface protection means as claimed in claim 1 using additive and subtractive methods combines. This method is a combination of the additive and subtractive method (above), subtracting from the nominal disc thickness in the data region and adding to the nominal disc thickness on the disc perimeter.

4. A disc surface protection means as claimed in claim 1 using a thin band. This method uses a separately formed band to create a rim around the perimeter of the disc. This approach allows data surface protection to be added to discs already in circulation by adding the band to the perimeter and bottom surfaces of the disc, giving surface protection similar to that of the solutions outlined above. A fitting tool can be used to more easily and accurately apply the band to the disc if necessary.
